(19) United States
(12) Patent Application Publication
(10) Pub. No.: US 2015/0308557 A1
(43) Pub. Date: Oct. 29, 2015

(54) ADAPTER ASSEMBLY

(71) Applicant: SIEMENTS AKTIENGESELLSCHAFT, München (DE)

(72) Inventors: GEORG BOEING, Rottenburg (DE); WOLFGANG SCHNURR, Nehren (DE)

(21) Appl. No.: 14/646,964

(22) PCT Filed: Nov. 25, 2013
(86) PCT No.: PCT/EP2013/074540

§ 371 Date: May 22, 2015

(30) Foreign Application Priority Data
Nov. 26, 2012 (EP) 12194252.8

(51) Int. Cl. F16H 57/025; F16H 57/04

(52) U.S. Cl. CPC F16H 57/025; F16H 57/0464; F16H 57/0471

(57) ABSTRACT

An adapter assembly for connecting a transmission unit and a motor unit-includes an adapter housing; a bearing disposed in the adapter housing; an adapter shaft rotatably mounted in the bearing; at least one lubricant chamber encompassing the adapter shaft for receiving lubricant and configured to supply the lubricant to the bearing; and a lubricant seal surrounding the adapter shaft on the motor side of the bearing for sealing the lubricant chamber from the motor side of the adapter assembly. The adapter assembly has at least one first channel supplying the lubricant from the surroundings of the adapter assembly to the lubricant chamber. The lubricant chamber is connected to the transmission side of the adapter assembly via a transmission-side opening in the adapter assembly, and/or the adapter assembly has a second channel configured to discharge the lubricant from the lubricant chamber into the surroundings of the adapter assembly.

The invention relates to an adapter assembly for connecting a transmission unit to a motor unit, a modular system, and a method for manufacturing a lubricant circuit in a drive group.

In order to allow connection of a motor unit and a transmission unit, it is often necessary to arrange an adapter assembly between the two units, particularly when motors and transmissions from different manufacturers are combined, wherein said adapter unit adapts the respective interfaces of the two units to each other and connects them together in a non-rotatable manner via an adapter shaft. Such an adapter for connecting an electric motor to a transmission is disclosed in DE-A-196 37 361 (SEW Eurodrive) 26 Mar. 1998 and in U.S. Pat. No. 5,934,156 (Phillips Allyn E.) 10 Aug. 1999, wherein the latter document is considered to be the closest prior art.

In this case, the adapter shaft of the adapter assembly is usually rotatably supported in individual bearings, preferably rolling bearings. In order to reduce friction in these bearings, use is customarily made of enclosed bearings with lifetime lubrication, e.g. 2Z rolling bearings. The lifetime of the rolling bearings is limited by the lifetime of the lubricant. Once the maximum lifetime of the lubricant in the bearings has been reached, the lubricant or the bearings must be replaced, resulting in maintenance costs and lengthy downtimes, and possibly in associated production stoppage.

Alternatively, it is also customary to provide means of relubrication with grease. The relubrication with grease is usually a manual operation which must take place at regular intervals. The planning, organization and performance of such manual lubrication tasks, which must be repeated periodically, is associated with considerable expense. Moreover, the accessibility of the adapter assembly may be restricted.

The object of the present invention is therefore to provide an improved adapter assembly.

The object is achieved by an adapter assembly for connecting a transmission unit to a motor unit, comprising an adapter housing, at least one bearing located in the adapter housing, an adapter shaft which is rotatably supported in the bearing and has a shaft axis, at least at least one lubricant chamber which extends annularly around the adapter shaft and is provided for the purpose of holding lubricant, wherein the lubricant chamber is connected to the bearing such that the lubricant can be supplied from the lubricant chamber to the bearing, and a lubricant seal which surrounds the adapter shaft on the motor side of the bearing and is provided for the purpose of sealing the lubricant chamber relative to the motor side of the adapter assembly, wherein the adapter assembly has at least one first channel, through which lubricant can be supplied from the environment of the adapter assembly to the lubricant chamber, and wherein the lubricant chamber has a connection to the transmission side of the adapter assembly, via a transmission-side opening in the adapter assembly, said opening giving access to the adapter shaft on the transmission side of the adapter assembly, and/or the adapter assembly has a second channel, through which lubricant can be drained from the lubricant chamber into the environment of the adapter assembly. The object of the invention is also achieved by a method for manufacturing a lubricant circuit in a drive group, wherein said drive group comprises an adapter assembly for connecting a transmission unit to a motor unit and a transmission unit which is connected to the adapter assembly, comprising steps as follows: forming a lubricant chamber which extends annularly around an adapter shaft of the adapter and is provided for the purpose of holding lubricant, wherein the lubricant chamber is connected to at least one bearing in which the adapter shaft is rotatably supported, such that the lubricant can be supplied from the lubricant chamber to the bearing; arranging a lubricant seal, which surrounds the adapter shaft, on a motor side of the bearing for the purpose of sealing the lubricant chamber relative to the motor side of the adapter assembly; forming a lubricant supply to the lubricant chamber by means of at least one first channel, through which lubricant can be supplied from the environment of the adapter assembly to the lubricant chamber; forming a lubricant drain from the lubricant chamber by means of a connection of the lubricant chamber to the transmission side of the adapter assembly via a transmission-side opening of the adapter assembly, said opening giving access to the adapter shaft on the transmission side of the adapter assembly, and/or via a second channel; and connecting the lubricant drain and the lubricant supply by means of a lubricant line.

The adapter assembly may be designed in two or more parts, having a transmission-side adapter and a motor-side adapter. The transmission-side adapter is suitable for connecting to a first rotational member, e.g. for attaching to a transmission; the motor-side adapter is suitable for connecting to a second rotational member, e.g. for attaching to a motor. In this case, the adapter may comprise a component, in particular a mounting flange, which can be mounted on, in particular flanged onto, a transmission or a motor. In particular, said component may be an integrally manufactured structural unit, made of e.g. gray cast iron, such as a motor bearing bracket or a coupling skirt.

In the context of the present description, the terms “motor” and “motor unit” are not restricted to a motor, in particular an electric motor, but encompass all drives and drive units for driving a first rotational member such as a transmission, e.g. hydraulic drives, pulleys, couplings, etc. The term “transmission” is equally broad in scope, i.e. it encompasses all rotational members that can be rotationally driven by a second rotational member such as a motor.

The transmission side of a bearing is that side of the bearing which faces a transmission. The expression “motor side” should be understood analogously.

The inventive adapter assembly serves as a connecting element for connecting a motor shaft of a motor unit to an input shaft of a transmission. The inventive adapter assembly has a lubricant chamber, sealed relative to the motor side of the adapter assembly, for providing lubricant, wherein said lubricant can be supplied from the lubricant chamber, which serves to hold lubricant, to points of friction in the transmission-side bearing or the motor-side bearing. In this case, the lubricant in the lubricant chamber is prevented from escaping from the lubricant chamber on the motor side by the lubricant seal which surrounds the adapter shaft on the motor side.

The invention is based on the idea of allowing the lubricant in the bearings of the adapter assembly to be exchanged or replaced during live operation of the adapter assembly, by providing a supply opening and a discharge opening for the lubricant chamber which is connected to the bearings. It is thereby possible to form a lubricant circuit through the adapter assembly. This means that the lubricant in the bearings is not always the same, and therefore the lifetime of the lubricant is extended and the maintenance intervals of the adapter assembly increased accordingly. The inventive adapter assembly therefore has considerably longer maintenance intervals than conventional adapter assemblies.

The lubricant can be cleaned in this lubricant circuit, e.g. by means of an oil filter. The lubricant can also be cooled in this lubricant circuit, e.g. by means of an oil cooler. By virtue of these measures, the lifetime of the lubricant and hence the maintenance intervals of the adapter assembly can be further increased.

The invention allows simple relubrication of the bearings of the adapter assembly, wherein said relubrication is integrated in the adapter assembly, uses lubricants such as grease, in particular low-viscosity grease, or oil, and is independent of other lubricant sources. The improved lubrication extends the lifetime of the adapter and/or the drive group. The present invention therefore provides a simple means of significantly extending the lifetime of the bearings and consequently increasing the maintenance intervals and reducing the maintenance costs and operating costs.

The invention uses the existing lubricant chamber geometry of an adapter assembly, in order to provide an additional and integrated lubrication facility. The inventive adapter assembly can be realized without costly modifications, or at least without substantial costly modification, to the structural units thereof. It need merely be ensured that lubricant can reach the lubrication points, i.e. the bearings, from the lubricant chamber. To this end, any side plates that are attached as seals on those side faces of the bearing oriented towards the lubricant chamber are removed.

Advantageous embodiments and developments of the invention are derived from the dependent claims. In this case, the inventive method can also be developed in accordance with the dependent device claims, and vice versa.

The adapter assembly may have a transmission-side bearing and a motor-side bearing, wherein the lubricant chamber is connected to both bearings and the lubricant seal is situated on the motor side of the motor-side bearing. The support of the adapter shaft in two bearings results in stabilization. In this case, the lubricant chamber is configured as to be connected to both bearings, meaning that both bearings can be integrated in the lubricant circuit. In order to achieve this, the lubricant seal for sealing the lubricant chamber relative to the motor side must be arranged on the motor side of the motor-side bearing.

The first and/or second channel may run transversely through the adapter housing relative to the shaft axis of the adapter shaft. The supply and discharge of lubricant are thereby facilitated, since the difficult access to the front side and/or flange side of the adapter assembly is avoided.

The lubricant seal may be a shaft sealing ring. This provides a simple and economical seal which is nonetheless effective. By virtue of the seal, the lubricant chamber for holding lubricant is closed relative to the motor side, i.e. lubricant which is filled into the lubricant chamber has no way of leaving the lubricant chamber other than via the connections that are provided to the transmission-side bearing and/or the motor-side bearing. The lubricant is then protected against harmful influences such as dust and dirt. Lubricant can nonetheless travel from the lubricant chamber to the bearings, where it performs its function of reducing friction, and vice versa; i.e. an exchange of lubricant can take place between the lubricant chamber for holding lubricant and the bearings.

According to a preferred embodiment, the lubricant seal surrounding the adapter shaft takes the form of a shaft sealing ring, in particular a radial shaft sealing ring with sealing lips. This can directly abut the adapter or be installed radially within an equalizing ring which in turn abuts the adapter.

The lubricant circuit may pass through the transmission unit, in particular through an oil sump of the transmission unit. This has the advantage that the transmission oil can also be used to lubricate the adapter assembly. This combination also involves the use of existing lubricant conditioning devices such as oil filters and oil coolers for the lubrication of the adapter assembly.

The lubricant chamber may be separated from a hollow space, which is situated further out radially, by a ring that extends between the transmission-side bearing and the motor-side bearing. The lubricant chamber for holding lubricant therefore has an annular wall, which extends between the transmission-side bearing and the motor-side bearing. This wall forms a radial boundary of the lubricant chamber in which the lubricant is situated. It is therefore possible to prevent lubricant from spreading into spatial regions or hollow spaces which are situated further out radially and in which the lubricant can contribute little or nothing to the relubrication. By virtue of the annular wall which encloses the lubricant chamber, the quantity of lubricant that must be filled into the lubricant chamber can be reduced, since the spread of the lubricant is essentially limited to the surroundings of the bearings.

According to a preferred embodiment, the ring (Le. the annular wall) is formed by a projection of the motor-side and/or transmission-side adapter. This projection can provide an axial support of the transmission-side bearing, such that the transmission-side bearing is developed as a locating bearing. A gap between the projection and the transmission-side adapter can be sealed against any passage of lubricant, i.e. any unwanted escape of the lubricant from the lubricant chamber, by means of a suitable seal, e.g. an O-ring. The projection and the motor-side adapter can be designed as mutually integral parts.

The annular wall may also be formed by an intermediate ring which is placed between the bearings. The intermediate ring can provide reciprocal axial support of the bearings, wherein the transmission-side bearing preferably takes the form of a locating bearing. Gaps between the intermediate ring and the adapters can be sealed against any passage of lubricant, i.e. any unwanted escape of the lubricant from the lubricant chamber, by means of suitable seals, e.g. by means of O-rings.

According to the invention, the adapter assembly comprises at least one channel via which lubricant can be supplied from the surroundings of the adapter assembly to the lubricant chamber and/or via which lubricant can be discharged from the lubricant chamber. This channel can therefore also be referred to as a lubricant transport channel. By “surroundings of the adapter assembly” is meant any lubricant chamber surrounding the adapter assembly. The channel therefore offers a simple means of supplying, from the surroundings of the adapter assembly, i.e. from the exterior, lubricant to the bearings which are arranged within the adapter assembly, without having to open the adapter assembly.

The at least one channel may also run through a motor-side adapter alone, i.e. be arranged in only one component of the adapter assembly. A standard component can therefore be used for the transmission-side adapter, while only the motor-side adapter need be equipped with a channel for the application in the adapter assembly. This simplifies the manufacture of the adapter assembly and supports the use of standardized unmodified components.

One end of the at least one channel may terminate at the motor-side bearing. If the at least one channel runs through the motor-side adapter, the shaft end of the channel advantageously terminates at the motor-side bearing. This means that a standard component can be used for the transmission-side adapter, while only the motor-side adapter need be equipped with a channel for the application in the adapter assembly.

According to a preferred embodiment, the adapter assembly comprises at least two channels, wherein a first channel of the at least two channels is an inlet channel for supplying lubricant to the lubricant chamber and a second channel of the at least two channels is an outlet channel for discharging lubricant from the lubricant chamber. By virtue of the combined arrangement of an inlet channel and an outlet channel in the adapter assembly, simple exchange of the lubricant in the lubricant chamber is possible.

Lubricant can be diverted into the transmission unit via the outlet channel. If this diversion of lubricant via the transmission-side outlet channel is combined with a lubricant feed, preferably via an inlet channel, it is possible to realize a circular lubrication, and preferably integrate this into a lubricant transport circuit of the transmission unit. The term circular lubrication designates a lubricant circuit comprising a reservoir, e.g. an oil well or an oil sump in the transmission unit, a supply to the point of friction, e.g. the inlet channel, and a return, e.g. via the outlet channel. A lubricant preparation or processing means, e.g. an oil filter or an oil cooling device, can also be connected in series. Using a circular lubrication, it is usually possible to operate using smaller quantities of oil in the system than are required for separate lubrication of transmission and adapter assembly. A circular lubrication can advantageously be realized using lubricating oil.

The adapter assembly may be an adapter for IEC motors, NEMA motors and servomotors, i.e. allowing the attachment of IEC motors, NEMA motors and servomotors (IEC=International Electrotechnical Commission; NEMA=National Electrical Manufacturers Association). In this case, the adapter assembly may be so configured that various coupling variants can be integrated in the motor-side adapter, e.g. an elastic coupling, a rigid coupling or a slip coupling, and a backstop. However, the motor-side adapter may also be simply embodied to hold the journal of the adapter shaft. This variant has the shortest overall length and is the most economical embodiment.

The adapter assembly may also allow the drive to be provided via a free shaft end. In this case, the motor-side adapter is so embodied as to surround a journal of the adapter shaft. In this embodiment, the rotational moment may be introduced into a transmission using a coupling or pulley which is attached to the free shaft end.

A preferred development of the invention takes the form of a drive group comprising an adapter assembly in one of the embodiments cited above and a transmission unit which is connected to the adapter assembly.

The drive group may comprise a lubricant circuit which runs from the first channel via the at least one bearing and the lubricant chamber, the transmission-side opening and/or the second channel, the transmission unit and a lubricant line back to the first channel.

A further preferred development of the invention takes the form of a modular system for creating an adapter assembly, comprising a plurality of transmission-side adapters which are suitable for connecting to different transmission units and each have a transmission-side bearing, a plurality of motor-side adapters which can be connected to at least one of the transmission-side adapters in each case and are suitable for connecting to different motor units and each have a motor-side bearing, and adapter shafts which are rotatably supported in the respective bearings.

The different transmission units may comprise transmissions of different sizes. The different motor units may comprise motors of different sizes.

The inventive adapter assembly modular system allows a multiplicity of different adapter variants, all of which ensure reliable transportation of lubricant to the rolling bearings which serve to support the adapter shaft, by forming a lubricant chamber in the interior of the adapter assembly. A significant improvement is thereby achieved relative to conventional adapter systems, in which it is not possible to form a lubricant chamber for holding lubricant in all adapter variants of the modular system. In the context of the inventive adapter assembly system, a motor-side adapter of one size may be combined with different transmission-side adapters or the corresponding transmissions. This is achieved inter alia in that the motor-side adapter of one size and the different transmission-side adapters have a shared interface. In this case, the motor-side interface of the motor-side adapter is adapted to the different motors (different motor types and different sizes within each motor type) and the transmission-side interface of the transmission-side adapter is adapted to the different transmission (different transmission types and different sizes within each transmission type), while the mutually facing interfaces of a motor-side adapter and a corresponding transmission-side adapter are identical (=shared interface).

If a specific number of motor-side adapters are provided for different motor types and motor sizes, each of which can be combined with a plurality of different transmission-side adapters via a shared interface, the required number of parts can be significantly reduced. By virtue of the inventive embodiment of the adapter assembly and the inventive adapter assembly system, it is therefore possible to increase the number of possible combinations of motors and transmissions, particularly if the number of parts is reduced. This means that many combinations of motors and transmissions are possible using modest storage.

According to a preferred embodiment, the method comprises a further step as follows: forming at least one channel via which lubricant can be supplied to the lubricant chamber from the surroundings of the adapter assembly, and/or forming at least one channel via which lubricant can be drained from the lubricant chamber. Once it has been formed, the at least one channel can be closed again by means of an easily removable sealing plug in this case. The adapter assembly therefore offers two different usage possibilities: either the adapter assembly is used in a conventional manner, if the sealing plug is not removed and the channel therefore remains unused; alternatively, the adapter assembly can be relubricated via the channel after the sealing plug has been removed, e.g. by means of pulling.

The at least one channel is preferably formed in the motor-side adapter. In this case, it is advantageous if the at least one channel runs exclusively in the motor-side adapter. This allows a standard adapter to be used as a transmission-side adapter, wherein a standard adapter does not require to be modified in any way for use in the adapter assembly.

The at least one channel is preferably formed by means of a material removing method, in particular drilling or milling.

The motor bearing brackets of the motor units, to which an inventive adapter assembly is connected, do not require modification. All of the characteristics required for the “longer maintenance intervals” option are implemented in the “motor-side adapter” component. The structural features comprise the possibility of installing a lubricant seal for sealing the lubricant chamber, said lubricant seal surrounding the adapter shaft and taking the form of a shaft sealing ring in particular, the design and the possibility of installing a component which radially encloses the lubricant chamber and extends between the transmission-side bearing and the motor-side bearing, in particular taking the form of a projection of the motor-side adapter or an intermediate ring which is placed between the bearings, and furthermore the possibility of incorporating at least one lubricant channel by means of casting, and the associated possibility of incorporating this retrospectively into the cast housing by manufacturing means as an option.

The above described characteristics, features and advantages of the present invention, and the means by which these are achieved, become clearer and easier to understand in the context of the following description of the exemplary embodiments, these being explained in greater detail with reference to the drawings in which:

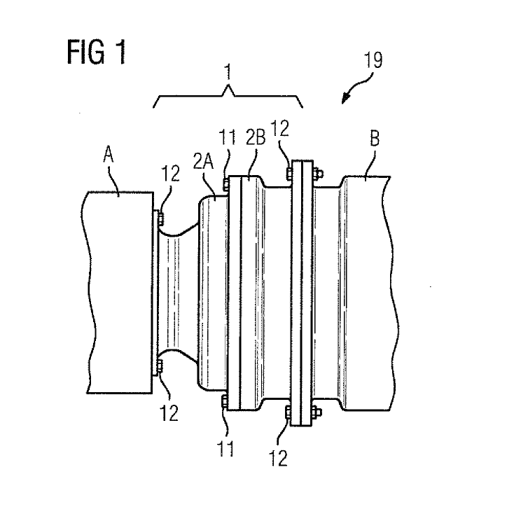

FIG. 1 shows a view of an adapter assembly which is arranged between a transmission unit and a motor unit;

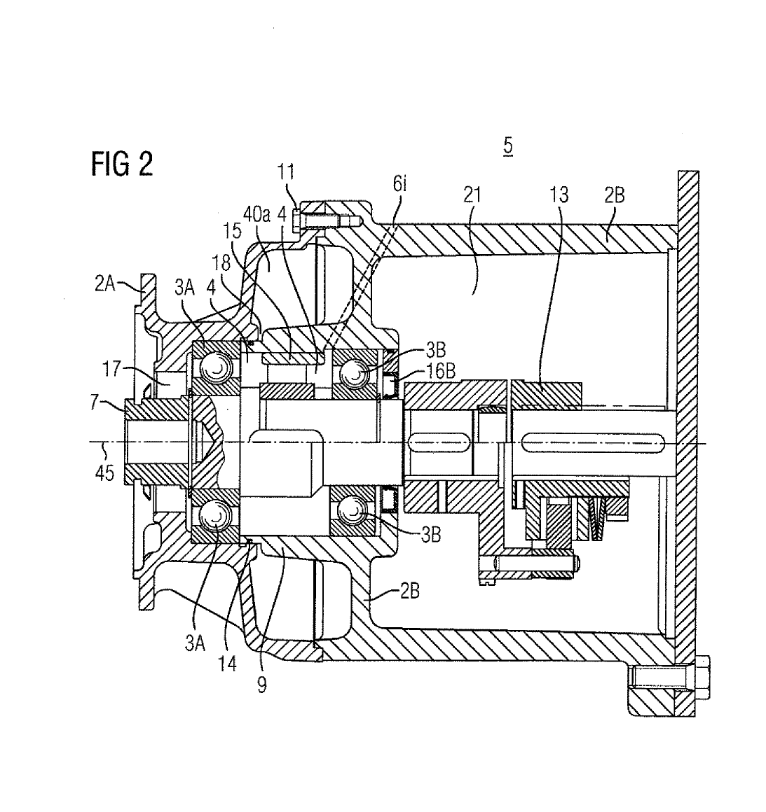

FIG. 2 shows sections of two different exemplary embodiments of an adapter assembly having a relatively long structural format in a first alternative;

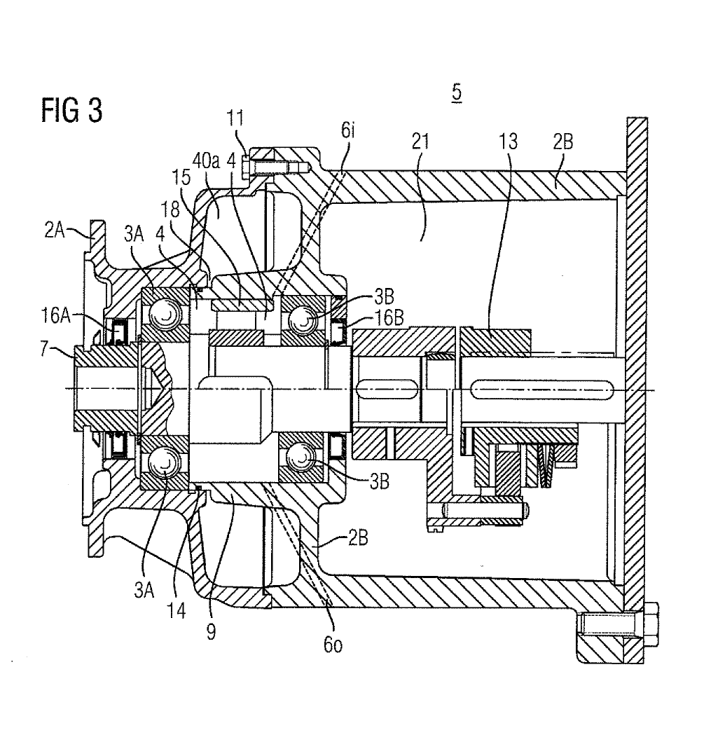

FIG. 3 shows sections of two different exemplary embodiments of an adapter assembly having a relatively long structural format in a second alternative;

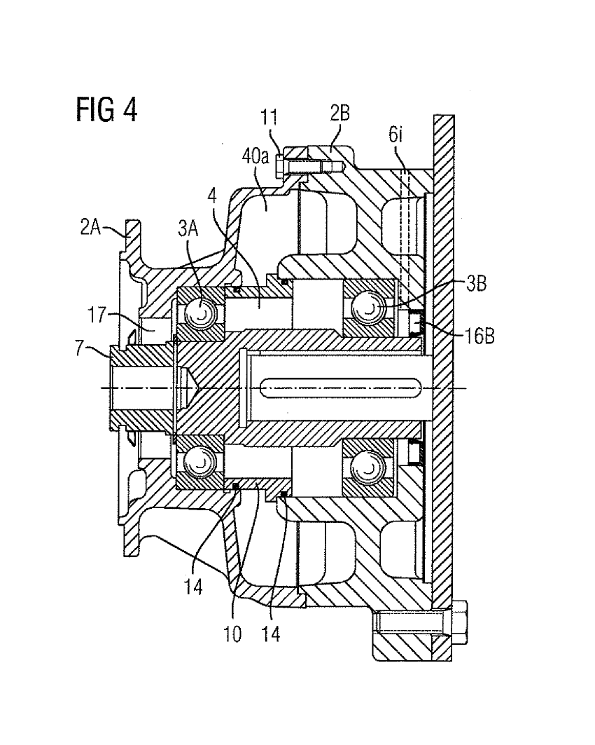

FIG. 4 shows a section of an adapter assembly having a relatively short structural format in a first alternative;

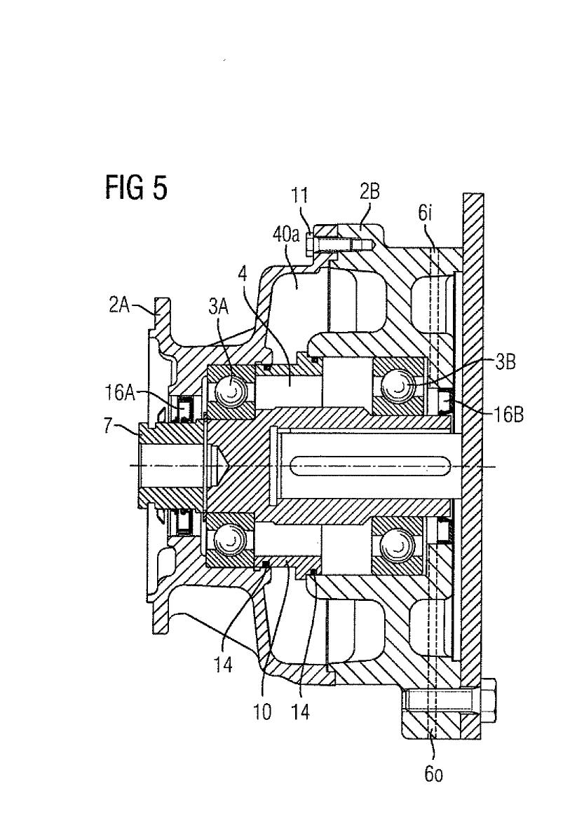

FIG. 5 shows a section of an adapter assembly having a relatively short structural format in a second alternative;

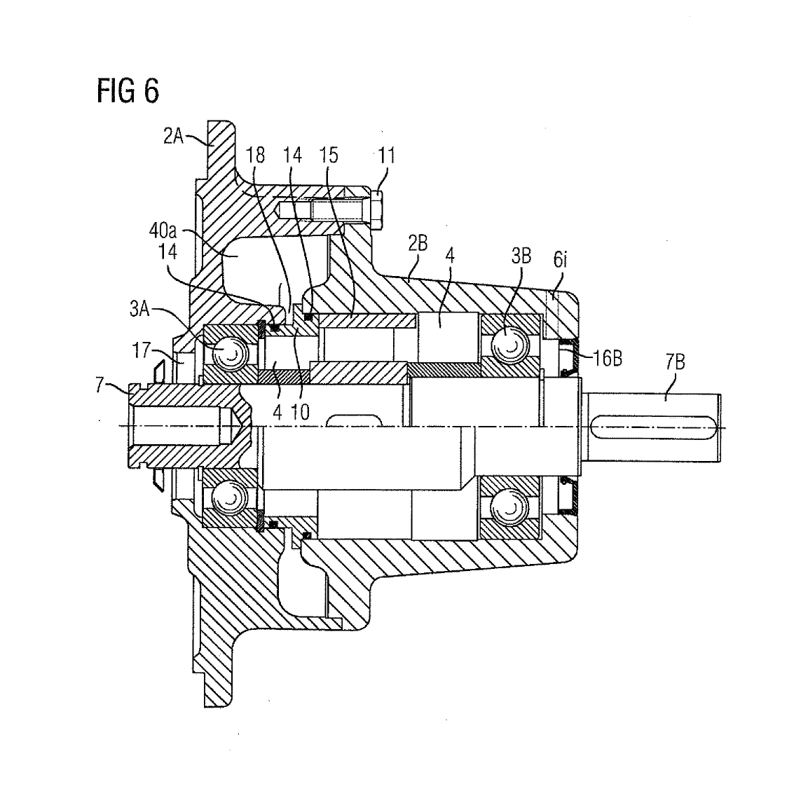

FIG. 6 shows a section of an adapter assembly having a free shaft end in a first alternative;

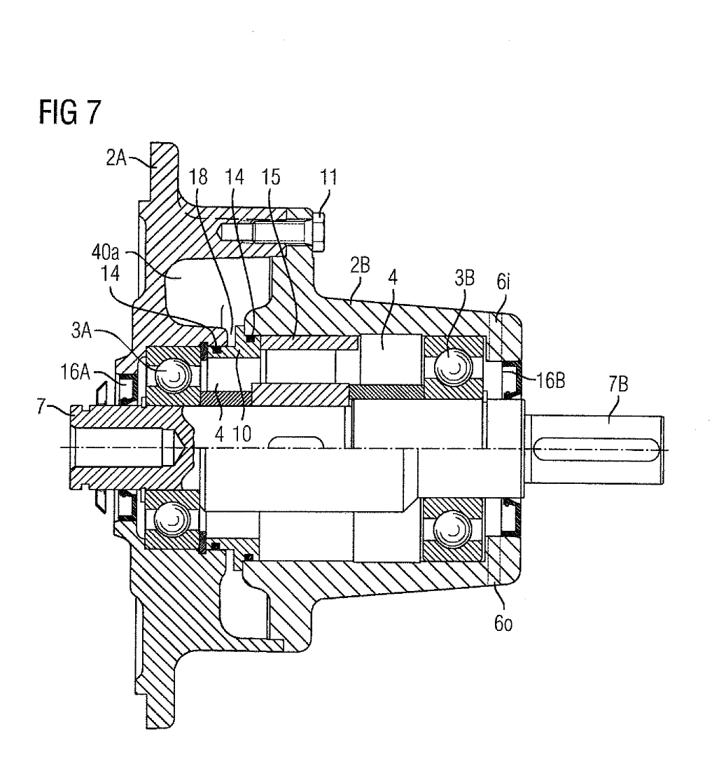

FIG. 7 shows a section of an adapter assembly having a free shaft end in a second alternative;

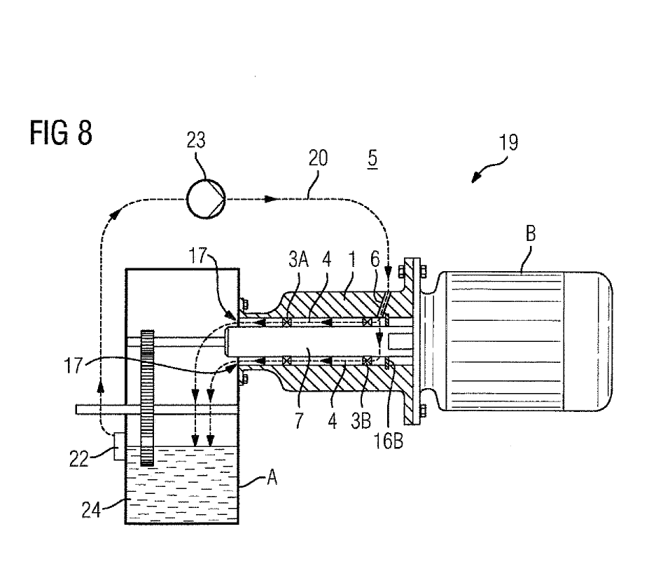

FIG. 8 shows a side view of a drive group, illustrated partially in section, comprising a coupling adapter, a transmission unit and a motor unit; and

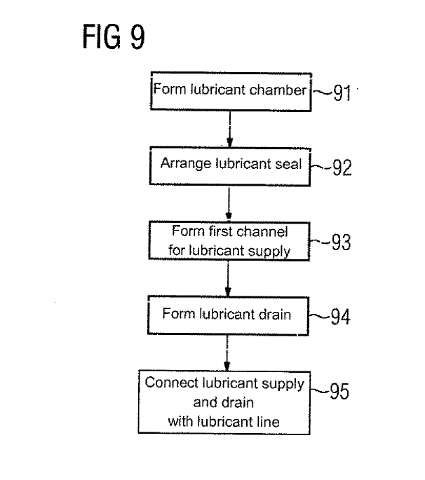

FIG. 9 shows a sequence of method steps for manufacturing a lubricant circuit in a drive group.

FIG. 1 shows a view of an adapter assembly 1 which is arranged between a transmission unit A and a motor unit B. The motor unit B may be designed as e.g. an electric motor as per the IEC standard for three-phase motors, while the transmission unit A may be e.g. an individually manufactured transmission. The adapter assembly 1 has a transmission-side adapter 2A and a motor-side adapter 2B, these being interconnected by means of connection screws 11. The transmission-side adapter 2A is preferably a standard motor bearing bracket. The motor-side adapter 28 is preferably a standard coupling skirt. The adapters 2A, 2B preferably consist of cast iron, preferably grey cast iron. The adapter assembly 1 is mounted onto the transmission unit A and the motor unit B by means of fixing screws 12 in each case.

FIG. 2 shows sections of two different exemplary embodiments of an adapter assembly 1 having a relatively long structural format. Since these exemplary embodiments are suitable for attachment of IEC motors, NEMA motors or servomotors, they are referred to as a “standard embodiment” here. The different embodiment variants relate to the installation of different coupling variants and a backstop. Different embodiments of a motor-side seal using shaft sealing rings are likewise illustrated here.

The adapter assembly 1 has a transmission-side adapter 2A and a motor-side adapter 2B, these being securely connected together by means of connection screws 11. Each of the two adapters 2A, 2B comprises a bearing 3A, 3B in each case. The transmission-side bearing 3A is also referred to as the A bearing, and the motor-side bearing 38 as the B bearing. The transmission-side bearing 3A is axially braced by the motor-side adapter 2B and is therefore designed as a locating bearing. The motor-side bearing 3B is designed as a non-locating bearing. The motor-side ball bearing can have side plates in this case. The transmission-side ball bearing does not have side plates, in order that axial penetration of lubricant through the bearing is not obstructed.

An adapter shaft 7 is rotatably supported in the bearings 3A, 3B and serves to form a non-rotatable connection between a motor unit and a transmission unit which are not shown here. No lubricant seal is provided on the transmission side of the transmission-side bearing 3A, in order that axial penetration of lubricant through the bearing 3A is not obstructed. A motor-side shaft sealing ring 16B is provided on the motor side of the motor-side bearing 3B. The motor-side shaft sealing ring 16B seals the adapter assembly relative to the coupling space 21. The shaft sealing ring 16B is designed as a radial shaft sealing ring with a sealing lip. The motor-side shaft sealing ring 16B which is installed in the motor-side adapter 2B can directly abut the motor-side adapter 2B (see lower half of FIG. 2), or be located radially within an equalizing ring 30 having a groove along its circumference and an O-ring 14 which is placed therein in order to provide a seal relative to the motor-side adapter 2B (see upper half of FIG. 2).

A lubricant chamber 4 is formed between the transmission-side bearing 3A and the motor-side bearing 3B in each case, and can be filled with a specified quantity of lubricant for lubricating the bearings 3A, 3B.

The supply of lubricant to the lubricant chamber 4 and the bearings 3A, 3B connected thereto takes place via a first channel 6i, which serves as an inlet channel. The inlet channel 6i is incorporated in the motor-side adapter 2B as a hole 6i for the supply of lubricant into the lubricant chamber 4 for holding the lubricant. The supplying hole 6i is disposed at the uppermost point in the motor-side adapter 2B. The draining of lubricant from the lubricant chamber 4 to the transmission side of the adapter assembly 1 takes place along the shaft axis 45 of the adapter shaft 7 via a transmission-side opening 17 of the adapter assembly 1, said opening 17 giving access to the adapter shaft 7 on the transmission side of the adapter assembly 1.

By virtue of the channel 6i and the opening 17, lubricant from the environment 5 of the adapter assembly can be supplied to the lubricant chamber 4 and/or lubricant can be discharged from the lubricant chamber 4. As a result of supplying lubricant through the inlet channel 6i and draining lubricant through the transmission-side opening 17 at the same time, a lubricant circuit through the adapter assembly 1 can be formed. In this way, a sufficient quantity of lubricating oil is available for the rolling bearings 3A, 3B at all times.

The upper half of FIG. 2 shows an exemplary embodiment in which a built-on free wheel 15 is radially arranged as a backstop within a projection 9 of the motor-side adapter 28 between the A and B bearings 3A, 3B, and a coupling 13 is arranged on the adapter shaft 7 in the region of the motor-side adapter 2B. In this case, the coupling can be an elastic coupling which is only used to transfer the rotational moment. The purpose of such a coupling may be to isolate detrimental influences such as axial and/or radial forces, vibrations or axial misalignment.

FIG. 3 shows two different exemplary embodiments of an adapter assembly in the two sectional halves which are separated by the horizontal, dash-dot line, said adapter assembly being configured in a similar manner to the exemplary embodiments illustrated in FIG. 2 but having, instead of the transmission-side opening 17, a second channel 6o through the adapter assembly 1, through which lubricant can be drained from the lubricant chamber 4 into the environment 5 of the adapter assembly 1.

A transmission-side shaft sealing ring 16A is provided on the transmission side of the transmission-side bearing 3A, and a motor-side shaft sealing ring 16B is provided on the motor side of the motor-side bearing 3B. The transmission-side shaft sealing ring 16A seals the adapter assembly relative to the transmission. The motor-side shaft sealing ring 16B seals the adapter assembly relative to the coupling space 21. The shaft sealing rings 16A and 16B are designed as radial shaft sealing rings with sealing lips. The motor-side shaft sealing ring 16B which is installed in the motor-side adapter 2B can directly abut the motor-side adapter 2B (see lower half of FIG. 2), or be located radially within an equalizing ring 30 having a groove along its circumference and an O-ring 14 which is placed therein in order to provide a seal relative to the motor-side adapter 2B (see upper half of FIG. 2).

Holes 6i and 6o are incorporated in the motor-side adapter 2B for the purpose of respectively supplying and discharging lubricant into or from the lubricant chamber 4 for holding the lubricant. The supplying hole 6i is positioned at the uppermost point of the motor-side adapter 2B. The draining hole 6o is positioned on the motor-side adapter 2B such that a sufficient quantity of lubricating oil is always available for the rolling bearings 3A, 38. By virtue of the channels 6i, 6o, lubricant can be supplied to the lubricant chamber 4 from the surroundings 5 of the adapter assembly and/or discharged from the lubricant chamber 4. As a result of supplying lubricant through the inlet channel 6i and draining lubricant through the outlet channel 6o at the same time, a lubricant circuit through the adapter assembly 1 can be formed.

FIGS. 4 and 5 each show a section of an adapter assembly 1 having a short structural format. The structure of the components forming the lubricating circuit and the functionality are essentially similar to the adapter assemblies having a long structural format as shown in FIGS. 2 and 3. The lubricant chamber 4 between the transmission-side bearing 3A and the motor-side shaft sealing ring 16B is in each case filled with a specific quantity of lubricant for lubricating the bearings 3A, 3B. The lubricant chamber 4 for holding the lubricant is separated by the installation of an intermediate ring 10 and by O-rings 14 from a lubricant chamber 40a which is situated further out radially and in which no lubricant is present.

The transmission-side bearing 3A is fixed and therefore designed as a locating bearing. The motor-side bearing 3B is a non-locating bearing. The intermediate ring 10 abuts the transmission-side bearing 3A with a transmission-side end face, and abuts the motor-side adapter 2B with a rib which projects from the circumference of the ring 10 and is disposed on the motor-side end thereof. The intermediate ring 10 has at its circumference two grooves with O-rings located therein, specifically a groove facing an annular surface of the transmission-side adapter 2A and a groove facing an annular surface of the motor-side adapter 2A, thereby forming a lubricant seal of the lubricant chamber 4 relative to the hollow space 40a which is situated further out radially.

FIG. 4 shows a first alternative, wherein lubricant is supplied to the lubricant chamber 4 via an inlet channel 6i and is drained from the lubricant chamber 4 via a transmission-side opening 17. No lubricant seal is provided on the transmission side of the transmission-side bearing 3A, in order that axial penetration of lubricant through the bearing 3A is not obstructed. A motor-side shaft sealing ring 16B is provided on the motor side of the motor-side bearing 3B. The motor-side shaft sealing ring 16B seals the adapter assembly relative to the motor.

By virtue of the channel 6i and the opening 17, lubricant from the environment 5 of the adapter assembly can be supplied to the lubricant chamber 4 and/or lubricant can be discharged from the lubricant chamber 4. As a result of supplying lubricant through the inlet channel 6i and draining lubricant through the transmission-side opening 17 at the same time, a lubricant circuit through the adapter assembly 1 can be formed. In this way, a sufficient quantity of lubricating oil is available for the rolling bearings 3A, 3B at all times.

FIG. 5 shows a second alternative, wherein lubricant is supplied to the lubricant chamber 4 via an inlet channel 6i and is drained from the lubricant chamber 4 via an outlet channel 6o. Holes 6 are incorporated in the motor-side adapter 2B for the purpose of respectively supplying and discharging lubricant into or from the lubricant chamber 4 for holding the lubricant. A transmission-side shaft sealing ring 16A is provided on the transmission side of the transmission-side bearing 3A, and a motor-side shaft sealing ring 16B is provided on the motor side of the motor-side bearing 3B. The transmission-side shaft sealing ring 16A seals the adapter assembly relative to the transmission. The motor-side shaft sealing ring 16B seals the adapter assembly relative to the motor.

By virtue of the channels 6i, 6o, lubricant can be supplied to the lubricant chamber 4 from the surroundings 5 of the adapter assembly and/or discharged from the lubricant chamber 4. As a result of supplying lubricant through the inlet channel 6i and draining lubricant through the outlet channel 6o at the same time, a lubricant circuit through the adapter assembly 1 can be formed.

FIGS. 6 and 7 each show a section of an adapter assembly 1 having a free shaft end 7B of the adapter shaft 7. The structure of the components forming the lubricating circuit and the functionality are essentially similar to the adapter assemblies shown in FIGS. 2 and 3 or in FIGS. 4 and 5.

FIG. 6 shows a first alternative, wherein lubricant is supplied to the lubricant chamber 4 via an inlet channel 6i and is drained from the lubricant chamber 4 via a transmission-side opening 17. FIG. 6 shows the installation of a backstop 15 in the upper half of the drawing. Also illustrated is the different embodiment of the motor-side seal in the form of a shaft sealing ring 16.

FIG. 7 shows a second alternative, wherein lubricant is supplied to the lubricant chamber 4 via an inlet channel 6i and is drained from the lubricant chamber 4 via an outlet channel 6o. In the upper and lower halves of FIG. 7, the annular lubricant chamber 4 for holding the lubricant is delimited radially inwards by the adapter shaft 7. The lubricant chamber 4 is delimited radially outwards by an intermediate ring 10 which surrounds the adapter shaft 7 and abuts the adapters 2A, 2B, wherein the intermediate ring 10 sits between a bearing outer ring of the transmission-side bearing 3A and the shoulder of the motor-side adapter 2B, An O-ring is used in each case between the intermediate ring 10 and an adapter 2A, 2B for the purpose of sealing the intermediate ring 10 relative to the adapters 2A, 2B.

A hollow space 40a, in which there is no lubricant, is formed radially outside the intermediate ring 10 in both variants. Two holes 6i and 6o are formed in the motor-side adapter 2B, respectively for supplying lubricant to and discharging lubricant from the lubricant chamber 4 for holding the lubricant.

FIG. 8 shows a side view of a drive group 19, illustrated partially in section, comprising a transmission unit A illustrated in section, a motor unit B illustrated in side view and, arranged between the transmission A and the motor B, an adapter assembly 1 illustrated in section for the purpose of coupling motor B and transmission A. The adapter assembly 1 may be designed as an integral part or comprise two or more interconnected adapters, along whose coaxial longitudinal axis an adapter shaft 7 is rotatably supported, said adapter shaft 7 being arranged in a transmission-side bearing 3A and a motor-side bearing 3B. On the transmission side of the transmission-side bearing 3A, the adapter shaft 7 is configured without a seal, in order to allow axial penetration of lubricant through the bearing 3A. On the motor side, a seal is provided by a motor-side shaft sealing ring 16B. A lubricant chamber 4 which annularly surrounds the adapter shaft 7 and is connected to the transmission-side bearing 3A and the motor-side bearing 3B is formed between the two bearings 3A, 3B.

An inlet channel 6i for supplying lubricant from an external environment 5 of the drive group 19 to the lubricant chamber 4 is formed in the adapter assembly 1, preferably in a motor-side adapter 2B of a multipart adapter assembly 1, wherein the inlet channel 6i opens into the lubricant chamber 4 between the motor-side shaft sealing ring 16B and the motor-side bearing 3B. Lubricating oil can be drained from the lubricant chamber 4 for holding lubricant, said lubricant chamber 4 surrounding the adapter shaft 7 and being connected to the bearings 3A, 3B, and diverted into the transmission unit A via a transmission-side opening 17 of the transmission-side adapter 1, by means of which opening 17 the adapter shaft 7 of the adapter 1 is connected to the transmission unit A. This ducting of oil necessitates a flow through the motor-side bearing 3B and the transmission-side bearing 3A.

The lubricating oil which is transported from the lubricant chamber 4 into the transmission unit A collects in an oil sump 24 of the transmission unit A, from where it travels e.g. via splash-type lubrication to an oil outlet in the housing wall of the transmission housing, and from there to an oil filter 22. The oil is conveyed outside the drive group 19 from the oil filter 22 to the inlet channel 6i, e.g. by means of an oil pump 23 that is preferably driven by a transmission shaft, via an external oil line 20 in which the oil can release heat to the surroundings. The filtered and cooled oil arrives back in the lubricant chamber 4 for holding the lubricant via the inlet channel 6i.

It is thereby possible to realize a circular lubrication, which can preferably be integrated into a lubricant transport circuit of the transmission unit A. In this case, the term circular lubrication refers to a lubricant circuit comprising a reservoir, e.g. an oil well or an oil sump 24 in the transmission unit A, a lubricant supply, e.g. the inlet channel 6i, to the lubrication points of the adapter assembly 1, in particular the bearings 3A and 3B of the adapter shaft 7, and a return of the lubricant to the reservoir, e.g. the diversion of lubricant from the coupling adapter assembly 1 via the outlet channel 6o.

As an alternative to the exemplary embodiment illustrated in FIG. 8 in which the lubricating oil is drained via the transmission-side opening 17, this can also be effected by means of an outlet channel 6o which is designed specifically for this purpose. In the case of a multipart structural format of the adapter assembly, the outlet channel 6o for draining lubricating oil from the lubricant chamber 4 to the external environment 5 of the drive group 19 may be embodied in the transmission-side adapter 2A. In this case, the outlet channel 6o can open directly into a corresponding inlet opening in the housing wall of the transmission A, or be connected to the transmission A by means of a lubricant line. Similarly, all other conceivable arrangements of the channels in the transmission-side and motor-side adapters 2A, 2B are also possible

FIG. 9 shows a sequence of steps for manufacturing a lubricant circuit in a drive group 19 as shown in FIG. 8, for example. The drive group 19 comprises an adapter assembly 1 for connecting a transmission unit A to a motor unit B, and a transmission unit A which is connected to the adapter assembly 1. The sequence has five steps.

In a first step 91, a lubricant chamber 4 is formed which extends annularly around an adapter shaft 7 of the adapter assembly 1 and is provided for the purpose of holding lubricant, said lubricant chamber 4 being connected to at least one bearing 3A, 3B in which the adapter shaft 7 is rotatably supported, such that the lubricant can be supplied from the lubricant chamber 4 to the bearing 3A, 3B. For example, a hollow space which extends between the shaft bearings 3A, 3B and around the shaft 7 can be used as a lubricant chamber 4.

In a second step 92, a lubricant seal 16B which surrounds the adapter shaft 7 is arranged on a motor side of the bearing 3B in order to seal the lubricant chamber 4 relative to the motor side of the adapter assembly 1.

In a third step 93, a lubricant supply to the lubricant chamber 4 is formed by means of at least one first channel 6i through which lubricant can be supplied from the environment 5 of the adapter assembly 1 to the lubricant chamber 4.

In a fourth step 94, a lubricant drain from the lubricant chamber 4 is formed by means of a connection 17 of the lubricant chamber 4 to the transmission side of the adapter assembly 1 via a transmission-side opening 17 of the adapter assembly 1, said opening giving access to the adapter shaft 7 on the transmission side of the adapter assembly 1, and/or via a second channel 6o.

In a fifth step 95, the lubricant drain and the lubricant supply are connected together by means of a lubricant line 20, such that lubricant which is drained out of the adapter assembly 1 via the lubricant drain can be returned to the lubricant supply via the lubricant line 20. The lubricant which is returned to the lubricant supply via the line 20, preferably being cooled and/or cleaned at the same time, is again introduced into the lubricant chamber 4 of the adapter assembly 1 by the lubricant supply.

A continuous lubricant circuit is thereby formed in the drive group 19.

1.-9. (canceled)

10. An adapter assembly for connecting a transmission unit to a motor unit, comprising
an adapter housing,
at least one bearing disposed in the adapter housing,
an adapter shaft which has a shaft axis and is rotatably supported in the bearing,
at least one lubricant chamber which extends annularly around the adapter shaft and holds a lubricant, wherein the lubricant chamber is connected to the at least one bearing and is configured to supply the lubricant from the lubricant chamber to the at least one bearing, and
a lubricant seal surrounding the adapter shaft on the motor side of the at least one bearing and sealing the lubricant chamber relative to the motor side of the adapter assembly, and
at least one first channel configured to supply the lubricant from an environment of the adapter assembly to the at least one lubricant chamber,
wherein the at least one lubricant chamber is connected to the transmission side of the adapter assembly by way of a transmission-side opening in the adapter assembly, said transmission-side opening providing access to the adapter shaft on the transmission side of the adapter assembly, or the adapter assembly comprises a second channel configured to drain the lubricant from the lubricant chamber into the environment of the adapter assembly.

11. The adapter assembly of claim 10, further comprising a transmission-side bearing and a motor-side bearing, wherein the lubricant chamber is connected to both the transmission-side bearing and the motor-side bearing and the lubricant seal is disposed on the motor side of the motor-side bearing.

12. The adapter assembly of claim 10, wherein at least one of the first and second channel runs transversely through the adapter housing relative to the shaft axis of the adapter shaft.

13. The adapter assembly of claim 10, wherein the lubricant seal is a shaft sealing ring.

14. A drive group comprising
a transmission unit, and
an adapter assembly connected to the transmission unit,
wherein the adapter assembly comprises
an adapter housing,
at least one bearing disposed in the adapter housing,
an adapter shaft which has a shaft axis and is rotatably supported in the bearing,
at least one lubricant chamber which extends annularly around the adapter shaft and holds a lubricant, wherein the lubricant chamber is connected to the at least one bearing and is configured to supply the lubricant from the lubricant chamber to the at least one bearing, and
a lubricant seal surrounding the adapter shaft on the motor side of the at least one bearing and sealing the lubricant chamber relative to the motor side of the adapter assembly, and
at least one first channel configured to supply the lubricant from an environment of the adapter assembly to the at least one lubricant chamber,
wherein the at least one lubricant chamber is connected to the transmission side of the adapter assembly by way of a transmission-side opening in the adapter assembly, said transmission-side opening providing access to the adapter shaft on the transmission side of the adapter assembly, or the adapter assembly comprises a second channel configured to drain the lubricant from the lubricant chamber into the environment of the adapter assembly.

15. The drive group of claim 14, further comprising a lubricant circuit which runs from the at least one first channel via the at least one bearing and the at least one lubricant chamber, the transmission-side opening or the second channel, the transmission unit and a lubricant line back to the at least one first channel.

16. A modular system for constructing an adapter assembly, comprising
a plurality of transmission-side adapters connectable to different transmission units, with each transmission-side adapter having a transmission-side bearing,
a plurality of motor-side adapters connectable to at least one of the transmission-side adapters and to different motor units, with each motor-side adapter having a motor-side bearing, and
adapter shafts rotatably supported in the respective transmission-side bearing and motor-side bearings,
wherein the or each adapter assembly comprises
at least one lubricant chamber which extends annularly around the adapter shaft and holds a lubricant, wherein the lubricant chamber is connected to the at least one bearing and is configured to supply the lubricant from the lubricant chamber to the at least one bearing, and
a lubricant seal surrounding the adapter shaft on the motor side of the at least one bearing and sealing the lubricant chamber relative to the motor side of the adapter assembly, and
at least one first channel configured to supply the lubricant from an environment of the adapter assembly to the at least one lubricant chamber,
wherein the at least one lubricant chamber is connected to the transmission side of the adapter assembly by way of a transmission-side opening in the adapter assembly, said transmission-side opening providing access to the adapter shaft on the transmission side of the adapter assembly, or the adapter assembly comprises a second channel configured to drain the lubricant from the lubricant chamber into the environment of the adapter assembly.

17. A method for manufacturing a lubricant circuit in a drive group, which comprises a transmission unit and an adapter assembly connected to the transmission unit, the method comprising:
forming a lubricant chamber extending annularly around an adapter shaft of the adapter assembly and configured to hold a lubricant, wherein the lubricant chamber is connected to at least one bearing, in which an adapter shaft is rotatably supported, and wherein the lubricant chamber is configured to supply the lubricant from the lubricant chamber to the at least one bearing;
arranging a lubricant seal, which surrounds the adapter shaft, on a motor side of the bearing for sealing the lubricant chamber relative to the motor side of the adapter assembly;
supplying the lubricant to the lubricant chamber from an environment of the adapter assembly by way of at least one first channel;
forming as a lubricant drain a transmission-side opening in the adapter assembly, which provides access to the adapter shaft on the transmission side of the adapter assembly, or a second channel for draining the lubricant from the lubricant chamber to the transmission side of the adapter assembly, and
connecting the lubricant drain and the lubricant supply by way of a lubricant line.

18. The method of claim 17, wherein the lubricant circuit passes through the transmission unit.

19. The method of claim 17, wherein the lubricant circuit passes through an oil sump of the transmission unit.
